(19) United States
(12) Patent Application Publication
(10) Pub. No.: US 2024/0300492 A1
(43) Pub. Date: Sep. 12, 2024

(54) VEHICLE CONTROL APPARATUS

(71) Applicant: TOYOTA JIDOSHA KABUSHIKI KAISHA, Toyota-shi (JP)

(72) Inventor: Tetsuya FURUICHI, Toyota-shi (JP)

(73) Assignee: TOYOTA JIDOSHA KABUSHIKI KAISHA, Toyota-shi (JP)

(21) Appl. No.: 18/407,860

(22) Filed: Jan. 9, 2024

(30) Foreign Application Priority Data
Mar. 8, 2023 (JP) 2023-035282

(51) Int. Cl. B60W 30/14

(52) U.S. Cl. CPC B60W 30/143; B60W 2420/403; B60W 2420/408; B60W 2720/106

(57) ABSTRACT

A vehicle control apparatus is configured to be capable of executing a following travel control and a deceleration support control. The vehicle control apparatus is configured to determine whether the following travel control ends according to a driver's intention or the following travel control automatically ends regardless of the driver's intention, when the execution condition is satisfied before a predetermined time elapses from an end time point at which the following travel control ends, and more strongly suppress the deceleration support control when the following travel control ends according to the driver's intention than when the following travel control automatically ends.

### TECHNICAL FIELD

The present disclosure relates to a vehicle control apparatus capable of executing a following travel control for controlling an acceleration and a deceleration of a host vehicle in such a manner that the host vehicle travels with following a preceding vehicle, and a deceleration support control for decelerating the host vehicle when a predetermined execution condition is satisfied.

### BACKGROUND

Conventionally, there has been known a vehicle control device capable of executing a following travel control and a deceleration support control. For example, when an automatic end condition is satisfied in a state where a vehicle control device described in Patent Document 1 (hereinafter, referred to as a “first conventional device”) decelerate a host vehicle while executing the following travel control, the first conventional device continues to decelerate the host vehicle until a predetermined timing after the automatic end condition is satisfied. Accordingly, it is possible to reduce a possibility that a driver feels uncomfortable after the following travel control ends regardless of the driver's intention.

For example, the vehicle control device described in Patent Document 2 (hereinafter, referred to as “second conventional device”) executes the deceleration support control for decelerating the host vehicle when a predetermined execution condition is satisfied.

Patent Document 1: Japanese Patent Application Laid-Open No. 2021-123153

Patent Document 2: Japanese Patent Application Laid-Open No. 2020-111128

### SUMMARY

If the execution condition is satisfied so that the deceleration support control is executed after the driver intentionally ends the following travel control, the host vehicle decelerates even though the driver intentionally ends the following travel control. Therefore, a behavior of the host vehicle may be an unintended behavior of the driver. The behavior may give the driver an uncomfortable feeling.

The first conventional device and the second conventional device are not designed in consideration of the uncomfortable feeling given to the driver by the deceleration support control executed after the following travel control ends.

The present invention has been made to address the above-described problem. In other words, it is an object of the present invention to provide a vehicle control device capable of reducing a possibility that the deceleration support control which is executed after the following travel control ends gives the driver the uncomfortable feeling.

The vehicle control apparatus (10) (hereinafter, referred to as a “present disclosure apparatus”) according to the present disclosure is capable of executing a following travel control and a deceleration support control. The following travel control is a control for controlling an acceleration-deceleration state of a host vehicle in such a manner that said host vehicle travels with following a preceding vehicle or said host vehicle travels at a preset speed. The deceleration support control is a control for decelerating said host vehicle in such a manner that said deceleration coincides with a support deceleration when it is determined that a predetermined execution condition is satisfied based on a surround situation of said host vehicle.

The present disclosure apparatus is configured to:
determine whether said following travel control ends according to a driver's intention or said following travel control automatically ends regardless of the driver's intention (step 723), when said execution condition is satisfied before a predetermined time elapses from an end time point at which said following travel control ends (step 710 “No”); and
more strongly suppress said deceleration support control when said following travel control ends according to said driver's intention (step 723 “Yes”) than when said following travel control automatically ends (step 740, step750).

After the following travel control ends according to the driver's intention, the driver manually controls the acceleration-deceleration state of the host vehicle. Therefore, the driver is more attentive to a behavior of the host vehicle when the following travel control ends according to the driver's intention than when the following travel control automatically ends. Due to this, the deceleration support control executed after the following travel control ends according to the driver's intention is more likely to give the driver the uncomfortable feeling than the deceleration support control executed after the following travel control automatically ends. The present disclosure apparatus more strongly suppresses the deceleration support control when the execution condition is satisfied before the predetermined time elapses from the end time point at which the following travel control ends according to the driver's intention than when the following travel control automatically ends. Accordingly, it is possible to reduce the possibility that the deceleration support control executed after the following travel control ends according to the driver's intention gives the driver the uncomfortable feeling.

### BRIEF DESCRIPTION OF THE DRAWINGS

FIG. 1 is a schematic system configuration diagram of a vehicle control device according to an embodiment of the present disclosure.

FIG. 2 is an explanatory diagram of types of a deceleration support control executed by a vehicle control ECU shown in FIG. 1.

FIG. 3 is a graph illustrating a change in an acceleration caused by the deceleration support control executed when an end of a following travel control is an intentional end and an acceleration-deceleration state at an end of the following travel control is a constant speed state.

FIG. 4 is a graph illustrating a change in the acceleration caused by the deceleration support control executed when the following travel control is the intentional end and the acceleration-deceleration state at the end is a deceleration state.

FIG. 5 is a flowchart illustrating an ACC routine executed a CPU of the vehicle control ECU shown in FIG. 1.

FIG. 6 is a flowchart illustrating a predetermined time elapse determination routine executed by the CPU of the vehicle control ECU shown in FIG. 1.

FIG. 7 is a flowchart illustrating a deceleration support control routine executed by the CPU of the vehicle control ECU shown in FIG. 1.

### DETAILED DESCRIPTION

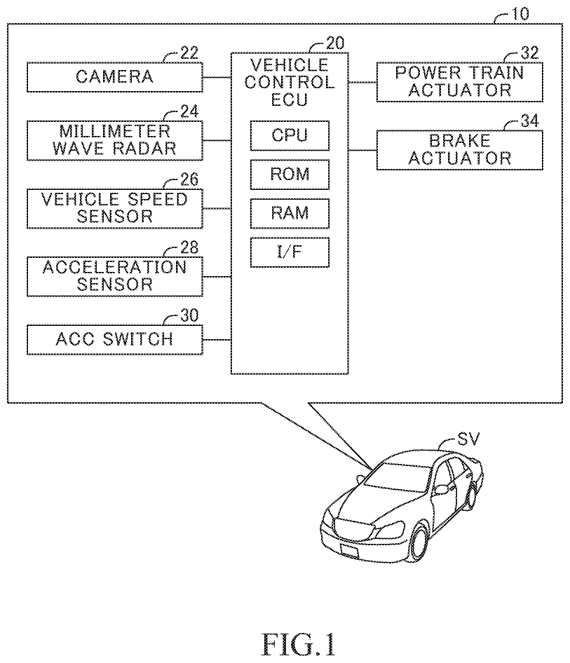

As illustrated in FIG. 1, a vehicle control device (hereinafter, referred to as a “present device 10”) according to a present embodiment is applied to a host vehicle SV and includes components illustrated in FIG. 1.

A vehicle control ECU20 is an ECU capable of executing a following travel control and a deceleration support control, and is hereinafter referred to as “ECU20”.

The following travel control is also referred to as an “ACC (Adaptive Cruise Control)”, and is a control for controlling an acceleration-deceleration state of the host vehicle SV so that the host vehicle SV travels with following a preceding vehicle of the host vehicle SV. The deceleration support control is a control for decelerating the host vehicle SV regardless of an operation of a driver when a predetermined execution condition is satisfied.

In the present specification, “ECU” is an electronic control unit including a microcomputer as a main part. The ECU is also referred to as a controller and a computer. The microcomputer includes a CPU (a processor), a ROM, RAM, an interface, and the like. The CPU realizes various functions by executing instructions (routines) stored in a memory (ROM). At least one function realized by ECU20 may be realized by a plurality of ECUs.

A camera 22 obtains image data by capturing a scene in front of the host vehicle SV. The camera 22 obtains camera object data and white line data based on the image data. The camera object data includes a position of an object located in front of the host vehicle SV with respect to the host vehicle SV. The white line data includes the position of a white line on a road on which the host vehicle SV is traveling with respect to the host vehicle SV. The camera 22 transmits the camera object data and the white line data to ECU20.

The millimeter wave radar 24 transmits a millimeter wave to the front of the host vehicle SV, and receives the millimeter wave reflected by the object (a reflected wave). Accordingly, the millimeter wave radar 24 obtains radar object data including “the position of the object with respect to the host vehicle SV” and “a relative speed Vr of the object with respect to the host vehicle SV”. The millimeter wave radar 24 transmits the radar object data to the ECU20.

A vehicle speed sensor 26 detects a vehicle speed Vs representing a speed of the host vehicle SV. An acceleration sensor 28 detects an acceleration G in the longitudinal direction of the host vehicle SV. The ECU20 obtains a detected value from each of the vehicle speed sensor 26 and the acceleration sensor 28.

An ACC switch 30 is arranged on a steering wheel (not shown). The driver of the host vehicle SV operates the ACC switch 30 when the driver starts the ACC. The driver operates ACC switch 30 when the driver ends the ACC. The ECU20 detects an operation of the driver with respect to the ACC switch 30.

A power train actuator 32 changes a driving force generated by a driving device (for example, an internal combustion engine and/or an electric motor) of the host vehicle SV. A brake actuator 34 controls a braking force applied to wheels of the host vehicle SV.

### (ACC)

Here, the ACC will be described.

The ECU20 executes an inter-vehicle control, which will be described later, when there is a preceding vehicle, and executes a constant speed control, which will be described later, when there is no preceding vehicle. The preceding vehicle is a vehicle located in front of the host vehicle SV and traveling on the same lane as a host lane on which the host vehicle SV is traveling. The ECU20 recognizes the host lane based on the white line data. The ECU20 recognizes vehicles located in front of the host vehicle SV based on the camera object data and the radar object data. The ECU20 recognizes the vehicle located in the host lane among the recognized vehicles as the preceding vehicle.

In the inter-vehicle control, the ECU20 obtains an ACC acceleration Gacc for matching an inter-vehicle distance between the host vehicle SV and the preceding vehicle with a preset distance. Then, the ECU20 controls the power train actuator 32 and the brake actuator 34 so that the acceleration G coincides with the ACC acceleration Gacc. For example, Japanese Patent Application Laid-Open No. 2014-148293, Japanese Patent Application Laid-Open No. 2006-315491, Japanese Patent No. 4172434 and, Japanese Patent No. 4929777 and the like disclose the inter-vehicle control.

In the constant speed control, the ECU20 obtains the ACC acceleration Gacc for matching the vehicle speed Vs of the host vehicle SV with a preset vehicle speed. Then, ECU20 controls the power train actuator 32 and the brake actuator 34 so that the acceleration G coincides with the ACC acceleration Gacc.

The ECU20 ends the ACC according to (by) the driver's intention, or the ECU 20 automatically ends the ACC regardless of the driver's intention. The end of ACC according to the driver's intention is referred to as “intentional end”, and the automatic end of ACC regardless of the driver's intention is referred to as “automatic end”.

For example, when the driver operates the ACC switch 30 or when the driver operates a brake pedal (not shown), the ECU20 ends the ACC according to the driver's intention. For example, when the camera 22 and the millimeter wave radar 24 cannot correctly detect the object, the ECU20 automatically ends the ACC regardless of the driver's intention.

### (Deceleration Support Control)

The ECU20 executes the deceleration support control for decelerating the host vehicle SV in such a manner that a deceleration Gd of the host vehicle SV coincides with a support deceleration Gdec when a predetermined execution condition is satisfied. The deceleration Gd is a negative acceleration G. As the deceleration Gd becomes higher, the host vehicle SV decelerates stronger. In the deceleration support control, the host vehicle SV decelerates regardless of the driver's operation of the brake pedal. Details of the deceleration support control are described in Japanese Patent Application Laid-Open No. 2020-111218, and thus description thereof is omitted. An example of the execution condition is described below.

When all of the following first to fifth conditions are satisfied, the ECU20 determines that the execution condition is satisfied.

First Condition: The ECU20 recognizes a deceleration target. The deceleration target is, for example, an obstacle (such as another vehicle, a pedestrian, and a structure), a travel restriction object (such as a road sign, a red signal, and a stopping line, which restrict the travel of the host vehicle SV), or a road structure (such as an intersection and a curve).

Second Condition: The distance (or TTC) between the host vehicle SV and the deceleration target is equal to or smaller than a predetermined distance (or a predetermined time). The TTC is an abbreviation of a Time To Collision. The TTC represents how long it takes for the host vehicle SV to collide with the deceleration target. The TTC is obtained by dividing the distance between the deceleration target and the host vehicle SV by the relative speed Vr of the deceleration target with respect to the host vehicle SV.

Third Condition: The driver releases an accelerator pedal (not shown).

Fourth Condition: The driver releases the brake pedal (not shown).

Fifth condition: The vehicle speed Vs is equal to or higher than a target speed Vtgt determined by the deceleration target.

### (Outline of Operation)

The ECU20 determines whether the end of the ACC is the intentional end or the automatic end when the execution condition is satisfied before a predetermined time has elapsed from an end time point at which the ACC ends. The ECU20 more strongly suppresses the deceleration support control when the end of the ACC is the intentional end than when the end of the ACC is the automatic end.

More specifically, the ECU20 obtains a support deceleration Gdec1 or an support deceleration Gdec2. The support deceleration Gdec1 is smaller than the original support deceleration Gdec. The support deceleration Gdec2 is a deceleration which makes the host vehicle SV decelerate from the deceleration Gd of when the execution condition is satisfied without changing a jerk (time-derivative of the acceleration G) of when the execution condition is satisfied (with keeping the jerk constant). When the support deceleration Gdec2 is obtained, the jerk does not change before and after the execution condition is satisfied, and thus the deceleration feeling of the driver does not change. Therefore, it can be said that the deceleration support control is suppressed more than in the normal state.

When the host vehicle SV decelerates regardless of the driver's operation immediately after the driver intentionally ends the ACC, the deceleration may give the driver the uncomfortable feeling. The ECU20 more strongly suppresses the deceleration support control when the end of the ACC is the intentional end than when the end of the ACC is the automatic end. Therefore, it is possible to reduce the possibility that the deceleration support control executed after the end of the ACC gives the driver the uncomfortable feeling.

### (Operation)

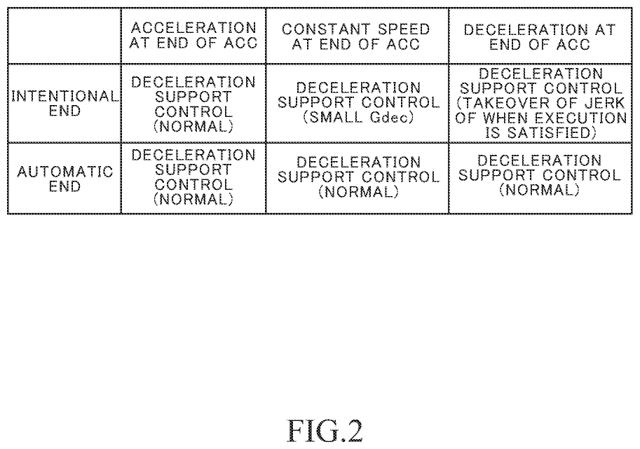

An operation of the present device 10 will be described in detail with reference to FIGS. 2 to 4.

As illustrated in FIG. 2, when the end of ACC is the intentional end, the ECU20 executes the deceleration support control that differs depending on the acceleration-deceleration state of the host vehicle SV at the end of the ACC (the acceleration-deceleration state at the end).

Specifically, the ECU20 specifies whether the acceleration-deceleration state at the end is (1) an acceleration state, (2) a constant speed state, or (3) a deceleration state.

### (1) Acceleration situation

When the ACC makes the host vehicle SV accelerate, a possibility that the preceding vehicle also accelerates is high. Therefore, normally, the execution condition is not satisfied. However, the execution condition may be satisfied when another vehicle traveling in the adjacent lane cuts in (interrupts) the host lane or the like. For this reason, the ECU20 executes a normal deceleration support control when the end of the ACC is the intentional end and the acceleration-deceleration state at the end is an acceleration state.

### (2) Constant speed condition

When the deceleration support control makes the host vehicle SV decelerate regardless of the driver's operation after the driver intentionally ends the ACC while the ACC makes the host vehicle SV travel at a constant speed without accelerating or decelerating the host vehicle, this deceleration is likely to give the driver the uncomfortable feeling is high.

Therefore, when the end of ACC is the intentional end and the acceleration-deceleration state at the end is the constant speed state, the ECU20 obtains the support deceleration Gdec1 smaller than the support deceleration Gdec which the normal deceleration support control uses. The ECU20 suppresses the deceleration assistance control by using the support deceleration Gdec1. For example, the ECU20 obtains the support deceleration Gdec1 by multiplying the support deceleration Gdec by a predetermined gain Ga (0≤Ga<1).

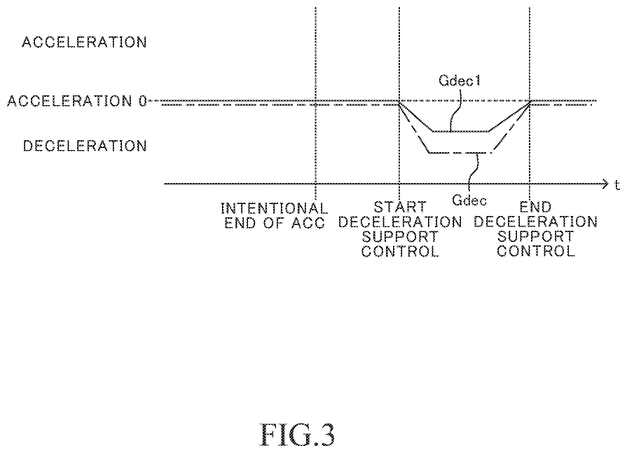

The change in the acceleration G due to the deceleration support control in the above case is shown in FIG. 3.

As shown in FIG. 3, the acceleration G of the host vehicle SV at the end of the ACC is “0”, and the host vehicle SV travels at the constant speed. The host vehicle SV travels at the constant speed after the ACC ends. Thereafter, when the execution condition is satisfied, the ECU20 decelerates the host vehicle SV in such a manner that the deceleration Gd of the host vehicle SV coincides with the support deceleration Gdec1.

In the deceleration support control shown in FIG. 3, the ECU20 decelerates the host vehicle SV in such a manner that an inclination of the deceleration Gd (a magnitude of the jerk in the deceleration Gd) becomes smaller than the normal deceleration support control. It should be noted that the deceleration support control ends when a predetermined end condition (for example, a condition that the vehicle speed Vs becomes the target speed Vtgt) is satisfied.

As a result, it is possible to reduce the possibility that the deceleration support control gives the driver the uncomfortable feeling.

### (3) Deceleration Condition

When the deceleration support control is executed after the driver intentionally ends the ACC while the ACC makes the host vehicle SV decelerate, the deceleration feeling is likely to differ before and after the deceleration support control is executed. Therefore, the deceleration support control may give the driver the uncomfortable feeling.

Therefore, when the end of the ACC is the intentional end and the acceleration-deceleration state at the end is the deceleration state, the ECU20 obtains the support deceleration Gdec2 which makes the host vehicle SV decelerate from the deceleration Gd of when the execution condition is satisfied without changing the jerk of the host vehicle SV. In other words, the ECUC20 obtains the support deceleration Gdec2 that takes over the deceleration Gd and the jerk just before the execution condition is satisfied. As a result, the deceleration feeling which the driver feels does not change immediately before and after the execution condition is satisfied. Effectively, the deceleration support control is not executed. Therefore, it is possible to reduce a possibility that the deceleration changes before and after the deceleration support control is executed, and to reduce a possibility that the deceleration support control gives the driver the uncomfortable feeling.

It should be noted that the ECU20 executes the normal deceleration support control when the acceleration G immediately before the execution condition is satisfied is greater than 0 (that is, when the host vehicle SV is accelerating).

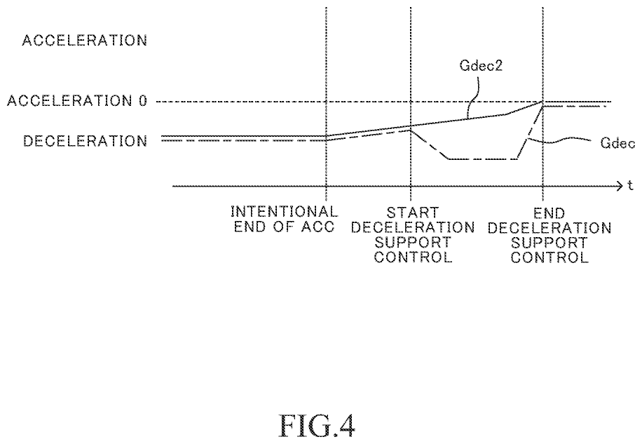

The change in the acceleration G due to the deceleration support control in the above case shown in FIG. 4.

As shown in FIG. 4, the acceleration G of the host vehicle SV at the end of the ACC is smaller than “0” and the host vehicle SV decelerates. The acceleration G is gradually increased after the end of the ACC (that is, the deceleration Gd is gradually decreased), but the acceleration G is smaller than “0” even when the execution condition is satisfied. The ECU20 obtains the support deceleration Gdec2 when the execution condition is satisfied.

### (Specific Operation)

### <ACC Routine>

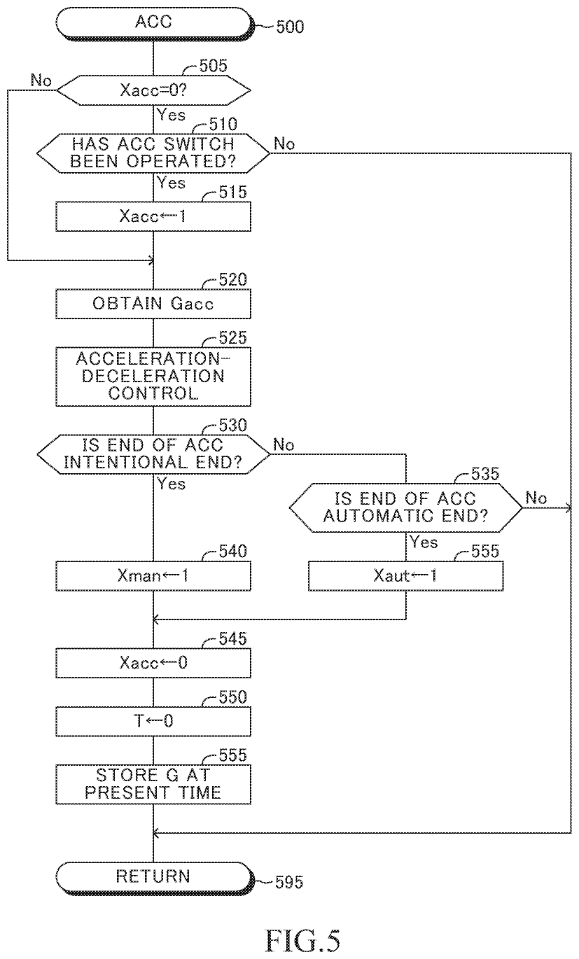

The CPU of ECU20 executes an ACC routine shown by a flowchart in FIG. 5 every time a predetermined time elapses.

When an appropriate time point comes, a process starts at step 500 of FIG. 5, and the process proceeds to step 505. In step 505, the CPU determines whether or not an ACC flag Xacc is “0”.

The ACC flag Xacc is set to “1” when the ACC switch 30 is operated while the ACC is not being executed, and is set to “0” when the ACC switch 30 is operated while the ACC is being executed. In an initialization routine executed when an ignition key switch (not shown) of the host vehicle SV is changed from an off position to an on position, the ACC flag Xacc is set to “0”.

When the ACC flag Xacc is “0”, the CPU makes a “Yes” determination in step 505, and the process proceeds to step 510. In step 510, the CPU determines whether or not the ACC switch 30 has been operated.

When the ACC switch 30 has not been operated, the CPU makes a “No” determination in step 510, and the process proceeds to step 595 so that the CPU ends the present routine tentatively.

When the ACC switch 30 has been operated, the CPU makes a “Yes” determination in step 510 and executes steps 515 to 530.

Step 515: the CPU sets the ACC flag Xacc to “1”.

Step 520: the CPU obtains the ACC acceleration Gacc as described above.

Step 525: the CPU controls the power train actuator 32 and the brake actuator 34 in such a manner that the acceleration G coincides with the ACC acceleration Gacc.

Step 530: the CPU determines whether or not the ACC ends according to the driver's intention by determining whether or not the driver has performed the above predetermined operation.

When the driver has not performed the predetermined operation, the ACC does not end according to the driver's intention. In this case, the CPU makes a “No” determination in step 530, and the process proceeds to step 535. In step 535, the CPU determines whether the ACC automatically ends regardless of the driver's intention.

When the ACC does not automatically end regardless of the driver's intention, the CPU makes a “No” determination in step 535, and the process proceeds to step 595. Consequently, the CPU continues to execute the ACC.

If the ACC flag Xacc is “1” when the process proceeds to step 505, the CPU executes steps 520 to 530. When the driver has performed the predetermined operation, the ACC ends according to the driver's intention. In this case, the CPU makes a “Yes” determination in step 530, and executes steps 540 to 555.

Step 540: the CPU sets an intention flag Xman to “1”.

The intention flag Xman is set to “1” when the ACC ends according to the driver's intention, and is set to “0” when a predetermined time has elapsed from an end time at which the ACC ends. The intention flag Xman is set to “0” in the initialization routine.

Step 545: the CPU sets the ACC flag Xacc to “0”.

Step 550: the CPU sets a timer T to “0”.

The timer T is a timer for counting an elapsed time from the end time of the ACC.

The step 555: the CPU stores the acceleration G at the present time.

After that, the process proceeds to step 595, and the CPU ends the present routine tentatively.

If the ACC automatically ends regardless of the driver's intention when the process proceeds to step 535, the CPU makes a “Yes” determination in step 535, and the process proceeds to step 555. In step 555, the CPU sets an auto flag Xaut to “1”. After that, the process proceeds to step 595, and CPU ends the present routine tentatively. The value of the auto flag Xaut is set to “1” when the ACC automatically ends, and is set to “0” when a predetermined time has elapsed since the end time of the ACC. The auto flag Xaut is set to “0” in the initialization routine.

### <Predetermined Time Elapse Determination Routine>

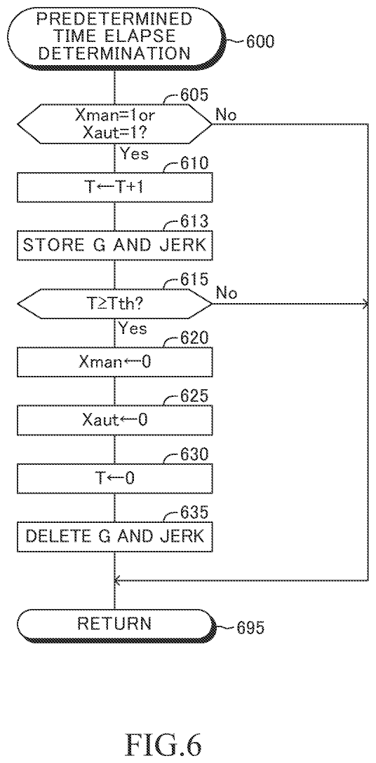

The CPU executes a predetermined time elapse determination routine shown by a flowchart in FIG. 6 every time a predetermined time elapses.

When an appropriate time point comes, a process starts at step 600 of FIG. 6, and the process proceeds to step 605. In step 605, the CPU determines whether either the intention flag Xman or the auto flag Xaut is “1”.

When either the intention flag Xman or the auto flag Xaut is “1”, the CPU makes a “Yes” determination in step 605 and executes steps 610 to 615.

Step 610: the CPU adds “1” to the timer T.

Step 613: the CPU stores the accelerations G and jerks at the present time.

Step 615: the CPU determines whether or not a value of the timer T is equal to or greater than a predetermined threshold Tth.

The threshold Tth is set in advance in such a manner that a predetermined time elapses from the end time of the ACC when the value of the timer T becomes equal to or larger than the threshold Tth.

When the value of the timer T is less than the threshold Tth, CPU determines “No” in step 615, and the process proceeds to step 695 and CPU ends the routine once.

When the value of the timer T is equal to or larger than the threshold Tth, the CPU makes a “Yes” determination in step 615 and executes steps 620 to 635.

Step 620: the CPU sets the intention flag Xman to “0”.

Step 625: the CPU sets the auto flag Xaut to “0”.

Step 630: the CPU sets the timer T to “0”.

Step 635: the CPU deletes the stored accelerations G and the jerks. After that, the process proceeds to step 695, and CPU ends the present routine tentatively.

When both the intention flag Xman and the auto flag Xaut are “0”, the CPU makes a “No” determination in step 605, and the process proceeds to step 695 so that the CPU ends the present routine tentatively. Normally, both the intention flag Xman and the auto flag Xaut are not set to “1”. However, even if both the intention flag Xman and the auto flag Xaut are set to “1”, the CPU makes a “No” determination in step 605, and the process proceeds to step 695 so that the CPU ends the routine tentatively.

### <Decembereleration Support Control Routine>

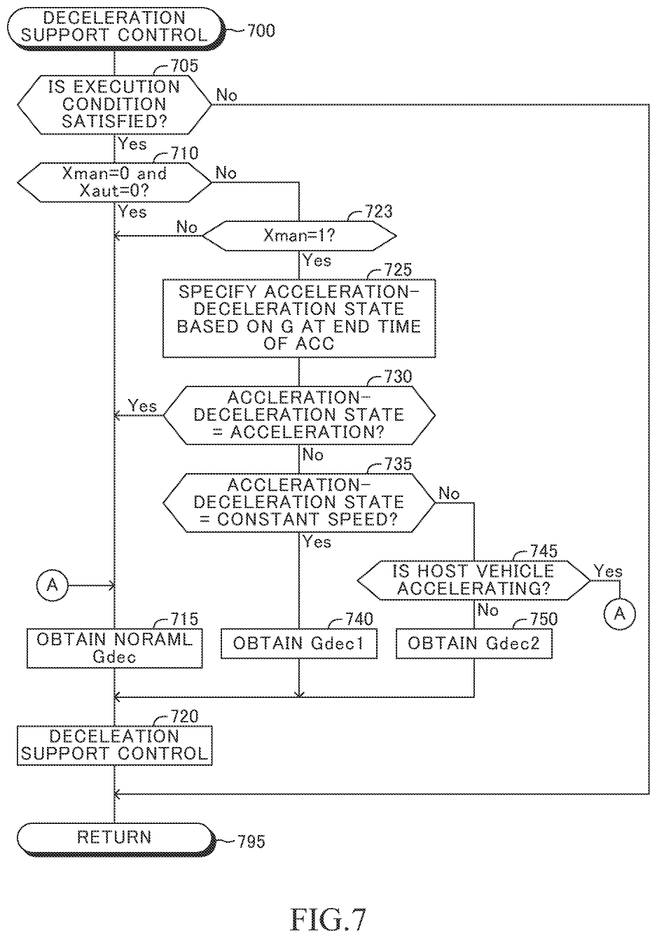

The CPU executes a deceleration support control routine shown by a flowchart in FIG. 7 every time a predetermined period elapses.

When an appropriate time point comes, a process starts at step 700 of FIG. 7, and the process proceeds to step 705. In step 705, the CPU determines whether or not the execution condition is satisfied.

When the execution condition is not satisfied, the CPU makes a “No” determination in step 705, and the process proceeds to step 795 so that the CPU ends the present routine tentatively.

When the execution condition is satisfied, the CPU makes a “Yes” determination in step 705, and the process proceeds to step 710. In step 710, the CPU determines whether or not both the intention flag Xman and the auto flag Xaut are “0”.

When both the intention flag Xman and the auto flag Xaut are “0”, the CPU makes a “Yes” determination in step 710 and executes steps 715 and 720.

Step 715: The CPU obtains the normal support deceleration Gdec.

Step 720: The CPU controls the power train actuator 32 and the brake actuator 34 in such a manner that the deceleration Gd coincides with the support deceleration Gdec.

After that, the process proceeds to step 795, and the CPU ends the present routine tentatively.

If at least one of the intention flag Xman and the auto flag Xaut is “1” when the process proceeds to step 710 (that is, if the predetermined time has not yet elapsed since the end time of the ACC), the CPU makes a “No” determination in step 710, and the process proceeds to step 723. In step 723, the CPU determines whether or not the intention flag Xman is “1”.

When the value of the intention flag Xman is “0”, the value of the auto flag Xaut is “1”. This is because both the intent flag Xman and the auto flag Xaut are not “1” and the CPU makes a “No” determination in step 710. In this instance, CPU determines “No” in step 723, and the process proceeds to step 715. As a result, the normal deceleration support control is executed.

On the other hand, when the intention flag Xman is “1”, the CPU makes a “Yes” determination in step 723, and executes steps 725 and 730.

Step 725: The CPU specifies, based on the acceleration G at the end time of the ACC (the acceleration G stored in step 555 shown in FIG. 5), whether the acceleration-deceleration state at the end is the acceleration state, the constant speed state, or the deceleration state.

Step 730: the CPU determines whether or not the acceleration-deceleration state at the end is the acceleration state.

When the acceleration-deceleration state at the end is the acceleration state, the CPU makes a “Yes” determination in step 730, and the process proceeds to step 715. As a result, the normal deceleration support control is executed.

When the acceleration-deceleration state at the end is not the acceleration state, CPU makes a “No” determination in step 730, and the process proceeds to step 735. In step 735, the CPU determines whether or not the acceleration-deceleration state at the end is the constant speed state.

When the acceleration-deceleration state at the end is the constant speed state, the CPU makes a “Yes” determination in step 735, and obtains the support deceleration Gdec1 smaller than the normal support deceleration Gdec (the support deceleration Gdec obtained in step 715). After that, the process proceeds to step 720.

On the other hand, when the acceleration-deceleration state at the end is not the constant speed state (that is, when the acceleration-deceleration state at the end is the deceleration state), the CPU makes a “No” determination in step 735, and the process proceeds to step 745. In step 745, CPU determines whether or not the host vehicle SV is currently accelerating based on the current acceleration G (i.e., when the execution condition is satisfied).

If the host vehicle SV is currently accelerating, the CPU makes a “Yes” determination in step 745 and the process proceeds to step 715. As a result, the normal deceleration support control is executed.

If the host vehicle SV is not currently accelerating, the CPU makes a “No” determination in step 745 and the process proceeds to step 750. In step 750, the CPU obtains the support deceleration Gdec2 that maintains jerk from the deceleration Gd of the host vehicle SV when the execution conditions are satisfied. The jerk is obtained based on the acceleration G and the jerk stored in step 635 illustrated in FIG. 6. After that, the process proceeds to step 720.

As described above, according to the present device 10, when the end of ACC is the intentional end, the deceleration support control is suppressed as compared with the case where the end of ACC is the automatic end. Accordingly, it is possible to reduce the possibility that the deceleration support control executed after the end of the intention gives the driver an uncomfortable feeling.

When the present embodiment is viewed from another viewpoint, the present embodiment is characterized in that the support deceleration Gdec is obtained based on the determination of whether the end of ACC is the intentional end or the automatic end and the acceleration-deceleration state at the end of the ACC.

The present disclosure should not be limited to the above-described embodiment, and may employ various modifications within the scope of the present disclosure. When the end of the ACC is the intentional end and the acceleration-deceleration state at the end is the constant speed state, the CPU may not decelerate the host vehicle SV by setting the support deceleration Gdec to “0”.

The camera 22 may be a stereo camera system or a monocular camera. The millimeter wave radar 24 may be a remote sensing device capable of detecting an object using a wireless medium other than millimeter wave. Further, the present device 10 may not include the millimeter wave radar 24 if the position of the object with respect to the host vehicle SV can be accurately detected based on the camera-object data.

The present apparatus 10 may be applied vehicles such as an engine vehicle, a Hybrid Electric Vehicle (HEV), a Plug-in Hybrid Electric Vehicle (PHEV), a Fuel Cell Electric Vehicle (FCEV), and a Battery Electric Vehicle (BEV). Furthermore, the present device 10 may also be applied to an autonomous control vehicle. Furthermore, the present disclosure can be regarded as a non-transitory storage medium in which a program for realizing the functions of the present device 10 is stored and which is readable by a computer.

What is claimed is:

1. A vehicle control apparatus configured to be capable of executing a following travel control and a deceleration support control, said following travel control being a control for controlling an acceleration-deceleration state f a host vehicle in such a manner that said host vehicle travels with following a preceding vehicle or said host vehicle travels at a preset speed, said deceleration support control being a control for decelerating said host vehicle in such a manner that a deceleration of said host vehicle coincides with a support deceleration when it is determined that a predetermined execution condition is satisfied based on a surround situation of said host vehicle,
wherein,
said vehicle control apparatus is configured to:
determine whether said following travel control ends according to a driver's intention or said following travel control automatically ends regardless of the driver's intention, when said execution condition is satisfied before a predetermined time elapses from an end time point at which said following travel control ends; and
more strongly suppress said deceleration support control when said following travel control ends according to said driver's intention than when said following travel control automatically ends.

2. The vehicle control apparatus according to claim 1, wherein said vehicle control apparatus is configured to make said support deceleration smaller when said following travel control ends according to said driver's intention and an acceleration-deceleration state at said end time point is a constant speed state in which said host vehicle travels at a constant speed without accelerating or decelerating than when said following travel control automatically ends.

3. The vehicle control apparatus according to claim 2, wherein said vehicle control apparatus is configured to obtain said support deceleration in such a manner that a magnitude of a jerk is smaller when said following travel control ends according to said driver's intention and said acceleration-deceleration state at said end time point is said constant speed state than when said following travel control automatically ends.

4. The vehicle control apparatus according to claim 1, wherein said vehicle control apparatus is configured to obtain said support deceleration in such a manner that said host vehicle decelerates from a deceleration at a time point at which said execution condition is satisfied without changing a jerk, when said following travel control ends according to said driver's intention and an acceleration-deceleration state at said end time point is a constant speed state in which said host vehicle travels at a constant speed without accelerating or decelerating.
